(19) United States
(12) Patent Application Publication
(10) Pub. No.: US 2012/0027370 A1
(43) Pub. Date: Feb. 2, 2012

(54) OPTICAL DEVICE

(75) Inventors: Andreas MATISS, Berlin (DE); Dirk Trommer, Berlin (DE)

(73) Assignee: u2t Photonics AG

(21) Appl. No.: 13/181,382

(22) Filed: Jul. 12, 2011

(30) Foreign Application Priority Data
Jul. 28, 2010 (EP) 10 007 829.4

(51) Int. Cl. G02B 6/00

(52) U.S. Cl. 385/140

(57) ABSTRACT

An embodiment of the invention relates to an optical device (10) comprising a coupler (20) having coupler inputs (I1, I2) and coupler outputs (O1-O4), and a connection network (30), wherein said connection network comprises connecting waveguides (41-44) which connect said coupler outputs with outputs of the connection network (O1′-O4′), and wherein at least one connecting waveguide of the connection network crosses at least one other connecting waveguide of the connection network. At least one connecting waveguide (42-44), which crosses other connecting waveguides less often than the connecting waveguide (41) with the maximum number of crossings with other connecting waveguides, is attenuated by an optical attenuation element (81-84, 91-94).

The invention relates to an optical device comprising a coupler and a connection network.

### BACKGROUND OF THE INVENTION

Publication “Athermal InP-Based 90°-Hybrid Rx OEICs with pin-PDs>60 Ghz for Coherent DP-QPSK Photoreceivers” (R. Kunkel, H.-G. Bach, D. Hoffmann, G. G. Mekonnen, R. Zhang, D. Schmidt and M. Schell, IPRM 2010, 22nd International Conference on Indium Phosphide and Related Materials, May 31-Jun. 4, 2010, Takamatsu Symbol Tower, Kagawa, Japan) discloses an optical device having the features of the preamble of claim 1. The device comprises a coupler having coupler inputs and coupler outputs, and a connection network. The connection network comprises connecting waveguides which connect the coupler outputs with outputs of the connection network. One of the waveguides of the connection network crosses two other waveguides while those other waveguides have just one crossing.

Devices like those described in the cited publication require low-loss crossings in order to achieve sufficiently low imbalances within the output waveguides of the connection network. To this end, the mentioned publication proposes a precise technological fabrication process.

However, the precision required for achieving sufficiently low imbalances, is very hard to achieve in mass production.

### OBJECTIVE OF THE PRESENT INVENTION

An objective of the present invention is to provide a device which requires less fabrication accuracy than prior art devices, but nonetheless reaches low imbalances.

A further objective of the present invention is to provide a device which can be fabricated at lower costs than prior art devices but show a comparable optical behaviour.

### BRIEF SUMMARY OF THE INVENTION

An embodiment of the invention relates to an optical device comprising a coupler having coupler inputs and coupler outputs, and a connection network, wherein said connection network comprises connecting waveguides which connect said coupler outputs with outputs of the connection network, and wherein at least one connecting waveguide of the connection network crosses at least one other connecting waveguide of the connection network, characterized in that at least one connecting waveguide, which crosses other connecting waveguides less often than the connecting waveguide with the maximum number of crossings with other connecting waveguides, is attenuated by an optical attenuation element.

The attenuation of a waveguide, i.e. the attenuation of the signal transmitted by the waveguide, may be caused by any optical attenuation material (e. g. metal) which is arranged in direct or indirect contact with the electromagnetic waves guided by the waveguide. For instance, the optical attenuation element may be formed by an attenuating layer on top or under the waveguide in order to cause optical losses.

However, in a preferred embodiment, the optical attenuation element comprises or is formed by a dummy waveguide which crosses the at least one connecting waveguide. In this manner, the optical attenuation element may be fabricated together with the connecting waveguides without further effort. Thus, additional costs for the fabrication of the optical attenuation element may be completely avoided.

The dummy waveguide may have unconnected ends which are separate from the coupler outputs and the outputs of the connection network. As such, the optical influence of the dummy waveguides may be restricted to the attenuation of the assigned waveguide.

Preferably, the waveguide width of the dummy waveguide corresponds to the waveguide width of the corresponding connecting waveguide.

Further, all connecting waveguides, which cross other connecting waveguides less often than the connecting waveguide with the maximum number of crossings with other connecting waveguides, are preferably each connected to at least one optical attenuation element.

Furthermore, all connecting waveguides, which cross other connecting waveguides less often than the connecting waveguide with the maximum number of crossings, are preferably each connected to a specific number of optical attenuation elements, wherein said specific number corresponds to the difference between said maximum number and the number of waveguide crossings of the respective connecting waveguide.

According to another preferred embodiment, the coupler comprises four coupler outputs and four connecting waveguides, each connecting waveguide connecting one of the coupler outputs with a corresponding output of the connection network. The first connecting waveguide may cross the second and third waveguides each once and the fourth connecting waveguide stands preferably clear of any crossing with any other connecting waveguide.

Preferably a dummy waveguide crosses the second connecting waveguide under the same angle as the first connecting waveguide crosses the third waveguide. A further dummy waveguide may cross the third connecting waveguide under the same angle as the first connecting waveguide crosses the second waveguide.

Furthermore, the fourth waveguide may be connected to the first and second optical attenuation elements, wherein the first optical attenuation element may be a dummy waveguide which crosses the fourth connecting waveguide under the same angle as the first connecting waveguide crosses the second waveguide, and wherein the second optical attenuation element may be a dummy waveguide which crosses the fourth connecting waveguide under the same angle as the first connecting waveguide crosses the third connecting waveguide.

The coupler may have two inputs and four outputs wherein signals leaving the outputs have phase differences between each other of 90° or multiple thereof. For instance, the coupler may be a multimode interference coupler.

The device may further comprise four photodetectors and two differential amplifiers, each of the amplifiers being connected to two photodetectors, wherein each photodetector is connected to one of the outputs of the connection network.

### BRIEF DESCRIPTION OF THE DRAWINGS

In order that the manner in which the above-recited and other advantages of the invention are obtained will be readily understood, a more particular description of the invention briefly described above will be rendered by reference to specific embodiments thereof which are illustrated in the appended drawings. Understanding that these drawings depict only typical embodiments of the invention and are therefore not to be considered to be limiting of its scope, the invention will be described and explained with additional specificity and detail by the use of the accompanying drawings in which

FIG. 1 shows a first exemplary embodiment of an inventive device; and

FIG. 2 shows a second exemplary embodiment of an inventive device.

### DETAILED DESCRIPTION OF THE PREFERRED EMBODIMENT

The preferred embodiment of the present invention will be best understood by reference to the drawings, wherein identical or comparable parts are designated by the same reference signs throughout.

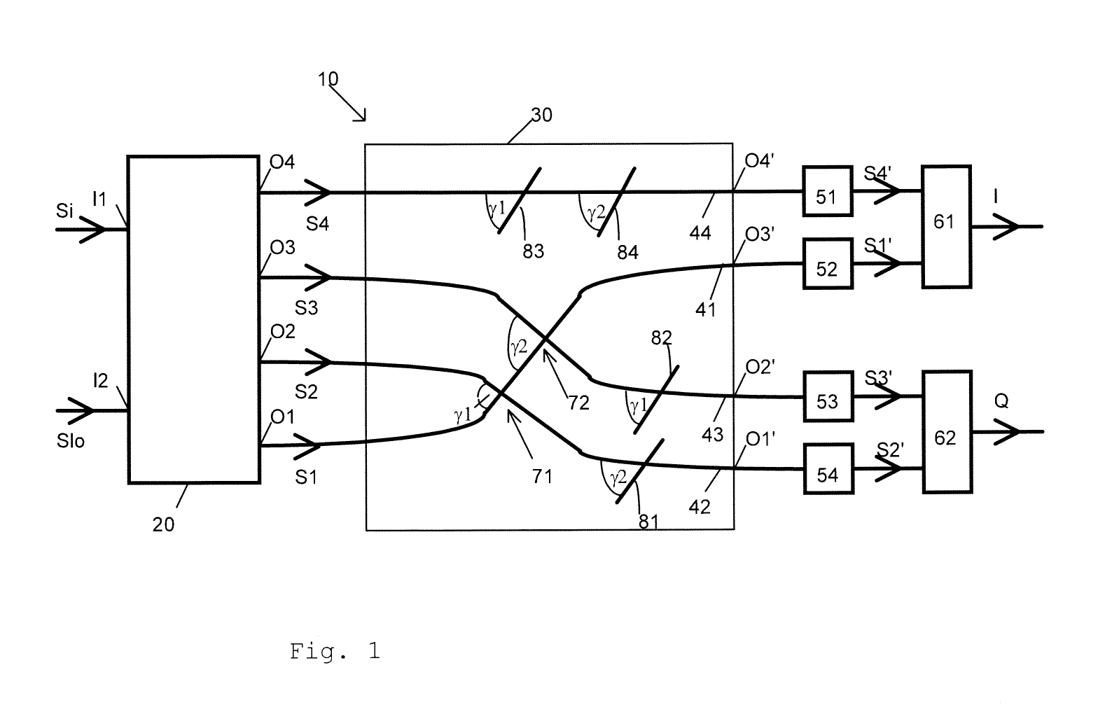

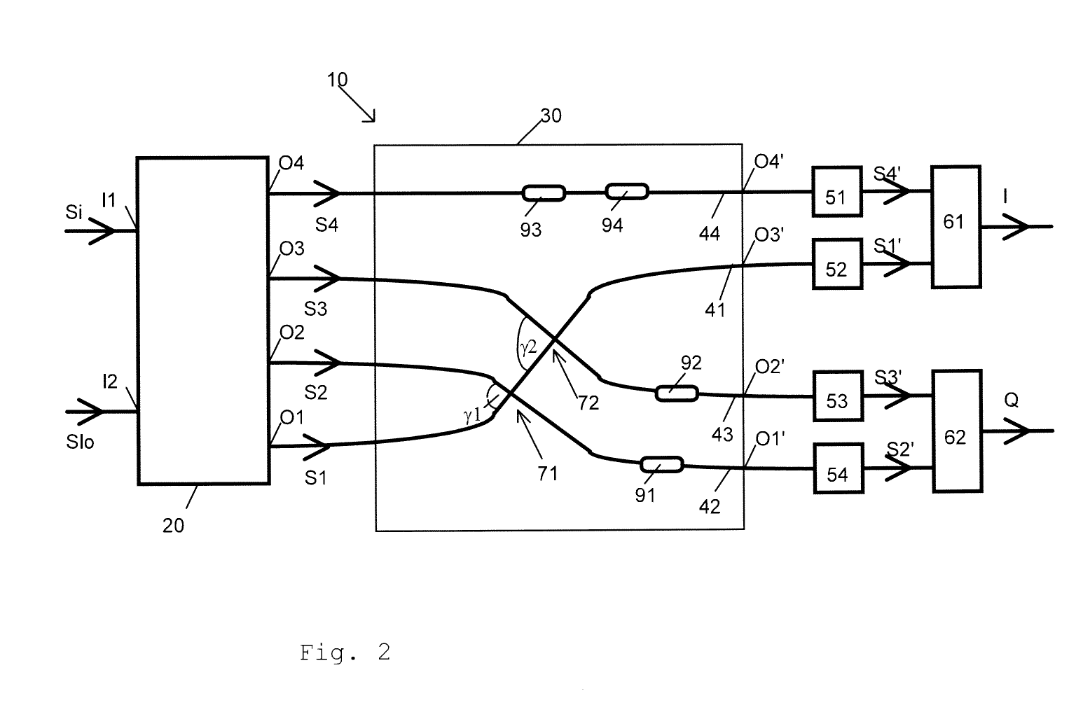

It will be readily understood that the present invention, as generally described and illustrated in the figures herein, could vary in a wide range. Thus, the following more detailed description of the exemplary embodiments of the present invention, as represented in FIGS. 1-2, is not intended to limit the scope of the invention, as claimed, but is merely representative of presently preferred embodiments of the invention.

FIG. 1 shows a first embodiment of a device 10 according to the invention. The device 10 comprises a multimode waveguide coupler 20 which forms a six-port 90° optical hybrid device. Instead of a multimode waveguide coupler, any other type of coupler may be incorporated into device 10, such as other types of 90°-hybrids or other types of couplers, for instance couplers based on internal 3 dB-splitters and internal phase shifters.

The waveguide coupler 20 has two optical inputs I1 and I2 and four optical outputs O1, O2, O3 and O4.

Inputs I1 and I2 may be used to enter a QPSK-modulated signal Si and a local oscillator signal Slo into the coupler 20.

The optical signals S1-S4, which leave the coupler outputs O1-O4, have phase differences between each other of 90° or multiple thereof. Supposing that signal S1, which leaves output O1, has a phase of 180°, signals S2, S3 and S4, which leave outputs O2, O3 and O4, will have phases of 270°, 90°, and 0°, respectively.

The multimode coupler 20 is connected to a connection network 30 which comprises four connecting waveguides 41, 42, 43 and 44. These waveguides connect the coupler outputs O1, O2, O3 and O4 with outputs O1′, O2′, O3′, and O4′ of the connection network 30.

The outputs O1′, O2′, O3′, and O4′ of the connection network 30 are connected to photodiodes 51-54 which absorb the electromagnetic signals S1-S4 transmitted by waveguides 41, 42, 43 and 44, respectively, and generate electrical signals S1′-S4′. Two differential amplifiers 61 and 62 that are each connected to two of the photodiodes 51-54, generate demodulated electrical QPSK signals I and Q.

As can be seen in FIG. 1, the first connecting waveguide 41 crosses the second waveguide 42 at a first crossing 71, and the third waveguide 43 at a second crossing 72. As such, if the fabrication process is not perfect, signal S1 that is transmitted via the first connecting waveguide 41, will suffer additional attenuation compared to signals S2-S4 in the other waveguides as the latter have to pass just one crossing (signals S2 and S3) or no crossing at all (signal S4). Thus, the signal amplitudes at the outputs O1′, O2′, O3′, and O4′ may slightly differ.

In order to address this problem, waveguides 42, 43, and 44 are in direct or indirect contact with optical attenuation elements. In the embodiment shown in FIG. 1, the optical attenuation elements are dummy waveguides 81-84 which cross the assigned connecting waveguide each under a predetermined angle γ1 or γ2 and thus cause additional attenuation.

The waveguide width of the dummy waveguides 81-84 preferably corresponds to the waveguide width of the connecting waveguides 41-44.

The dummy waveguide 81 that attenuates the second connecting waveguide 42, crosses the second waveguide 42 under the same angle γ2 as the first connecting waveguide 41 crosses the third connecting waveguide 43 at the second crossing 72. As such, the additional loss caused by dummy waveguide 81 corresponds to the additional loss caused by the second crossing 72, and the signal strength of signal S2 will better match with the signal strength of signal S1.

The dummy waveguide 82 that attenuates the third connecting waveguide 43, crosses the third waveguide 43 under the same angle γ1 as the first connecting waveguide 41 crosses the second connecting waveguide 42 at the first crossing 71. As such, the additional loss caused by dummy waveguide 82 corresponds to the additional loss caused by the first crossing 71, and the signal strength of signal S3 will better match with the signal strength of signal S1.

The fourth waveguide 44 is attenuated by a first dummy waveguide 83 and a second dummy waveguide 84. The first dummy waveguide 83 crosses the fourth connecting waveguide 44 under the same angle γ1 as the first connecting waveguide 41 crosses the second waveguide 42 at the first crossing 71, and the second dummy waveguide 84 crosses the fourth connecting waveguide 44 under the same angle γ2 as the first connecting waveguide 41 crosses the third waveguide 43 at the second crossing 72. As such, the additional losses caused by dummy waveguides 83 and 84 correspond to the additional losses caused by the first and second crossings 71 and 72, and the signal strength of signal S4 will better match with the signal strength of signal S1.

As apparent from the above, dummy waveguides 81-84 add additional optical losses to waveguides 42-44 which cross other waveguides less often than waveguide 41.

FIG. 2 shows a second embodiment of a device 10 according to the invention. In this embodiment the optical attenuation elements are formed by metal layers 91-94 which are arranged on top or below waveguides 42-44. The optical radiation of signals S2-S4 overlaps at least partly with the metal layers and is therefore attenuated.

In the embodiment shown in FIG. 2, the length and position of metal layer 91 is chosen such that the estimated, measured or simulated optical loss caused by metal layer 91 corresponds to the estimated, measured or simulated optical loss caused by crossing 72.

The length and position of metal layer 92 is chosen such that the estimated, measured or simulated optical loss caused by metal layer 92 corresponds to the estimated, measured or simulated optical loss caused by crossing 71.

The length and position of metal layer 93 is chosen such that the estimated, measured or simulated optical loss caused by metal layer 93 corresponds to the estimated, measured or simulated optical loss caused by crossing 71, and the length and position of metal layer 94 is chosen such that the estimated, measured or simulated optical loss caused by metal layer 94 corresponds to the estimated, measured or simulated optical loss caused by crossing 72.

As such, metal layers 91-94 cause additional optical losses to waveguides 42-44 which cross other connecting waveguides less often than waveguide 41 that has the maximum number of two crossings with other connecting waveguides.

In the embodiment shown in FIG. 2, metal layers 93 and 94 are separate units. Alternatively, a single metal layer may be applied which causes optical losses comparable to those of crossings 71 and 72.

### REFERENCE SIGNS

10 device

20 optical coupler

30 connection network

41-44 connecting waveguide

51-54 photodiode

61-62 differential amplifier

71 first crossing

72 second crossing

81-84 dummy waveguide

91-94 metal layer

I1, I2 optical input

I, Q demodulated electrical QPSK signal

O1-O4 optical output

O1′-O4′ outputs of the connection network

S1-S4 electromagnetic signal

S1′-S4′ electrical signal

Si QPSK-modulated signal

Slo local oscillator signal

γ1, γ2 angle of waveguide crossing

1. Optical device comprising a coupler having coupler inputs and coupler outputs, and a connection network,
wherein said connection network comprises connecting waveguides which connect said coupler outputs with outputs of the connection network, and
wherein at least one connecting waveguide of the connection network crosses at least one other connecting waveguide of the connection network,
characterized in that
at least one connecting waveguide, which crosses other connecting waveguides less often than the connecting waveguide with the maximum number of crossings with other connecting waveguides, is attenuated by an optical attenuation element.

2. Optical device according to claim 1, characterized in that said optical attenuation element comprises a dummy waveguide which crosses the at least one connecting waveguide.

3. Optical device according to claim 2, characterized in that said dummy waveguide has unconnected ends which are separate from the coupler outputs and the outputs of the connection network.

4. Optical device according to claim 2, characterized in that the waveguide width of the dummy waveguide corresponds to the waveguide width of the at least one connecting waveguide.

5. Optical device according to claim 1, characterized in that all connecting waveguides, which cross other connecting waveguides less often than the connecting waveguide with the maximum number of crossings with other connecting waveguides, are each attenuated by at least one optical attenuation element.

6. Optical device according to claim 5, characterized in that
all connecting waveguides, which cross other connecting waveguides less often than the connecting waveguide with the maximum number of crossings, are each attenuated by a specific number of optical attenuation elements,
wherein said specific number corresponds to the difference between said maximum number and the number of waveguide crossings of the respective connecting waveguide.

7. Optical device according to claim 1, characterized in that
said coupler comprises four coupler outputs and four connecting waveguides, each connecting waveguide connecting one of the coupler outputs with a corresponding output of the connection network,
wherein the first connecting waveguide crosses the second and third waveguides each once and
wherein the fourth connecting waveguide is free of any crossing with any other connecting waveguide.

8. Optical device according to claim 7, characterized in that an optical attenuation element, which attenuates the second connecting waveguide, is a dummy waveguide which crosses the second connecting waveguide under the same angle as the first connecting waveguide crosses the third waveguide.

9. Optical device according to claim 7, characterized in that an optical attenuation element, which attenuates the third connecting waveguide, is a dummy waveguide which crosses the third connecting waveguide under the same angle as the first connecting waveguide crosses the second waveguide.

10. Optical device according to claim 7, characterized in that
the fourth waveguide is attenuated by first and second optical attenuation elements,
wherein the first optical attenuation element is a dummy waveguide which crosses the fourth connecting waveguide under the same angle as the first connecting waveguide crosses the second waveguide, and
wherein the second optical attenuation element is a dummy waveguide which crosses the fourth connecting waveguide under the same angle as the first connecting waveguide crosses the third connecting waveguide.

11. Optical device according to claim 1, characterized in that the coupler has two inputs and four outputs wherein signals leaving the outputs have phase differences between each other of 90° or multiple thereof.

12. Optical device according to claim 10, characterized in that the coupler is a multimode interference coupler.

13. Optical device according to claim 1, characterized in that
the device further comprises four photodetectors and two differential amplifiers, each of the amplifiers being connected to two photodetectors, wherein each photodetector is connected to one of the outputs of the connection network.
